(19) United States
(12) Patent Application Publication
(10) Pub. No.: US 2009/0316660 A1
(43) Pub. Date: Dec. 24, 2009

(54) METHOD, SYSTEM, AND APPARATUS FOR HANDOVER AMONGST PLURALITY OF COMMUNICATION NETWORKS

(76) Inventors: Charles Perkins, Saratoga, CA (US); Mustafa Ergen, Oakland, CA (US)

Correspondence Address: GLOBAL IP SERVICES, PLLC, 10 CRESTWOOD LANE, NASHUA, NH, 03062, US

(21) Appl. No.: 12/396,489

(22) Filed: Mar. 3, 2009

Related U.S. Application Data
(60) Provisional application No. 61/132,938, filed on Jun. 24, 2008.

(51) Int. Cl. H04W 36/00

(52) U.S. Cl. 370/332; 370/331

(57) ABSTRACT

A method, system, and apparatus for enabling handover of a Mobile Station (MS) amongst a plurality of communication networks is provided. The MS operates in one or more communication networks of the plurality of communication networks using an Internet Protocol (IP) session. The method includes communicating one or more network parameters amongst the plurality of communication networks. The method further includes creating one or more datapath parameters based on one or more of the one or more network parameters. The method further includes altering one or more protocol stack parameters in the MS. Altering the one or more protocol stack parameters maintains the IP session operating the MS in the one or more communication networks.

### RELATED APPLICATIONS

Benefit is claimed under 35 U.S.C. 119(e) to U.S. Provisional Applications Ser. 61/132,938 entitled “METHOD AND SYSTEM FOR SINGLE RADIO SERVER THAT PERFORMS HANDOVER BETWEEN WIMAX AND 3GPP/2 WITH SINGLE OR DUAL RADIO” by Charles Perkins et al., filed on 24 Jun. 2008, which is herein incorporated in its entirety by reference for all purposes.

### FIELD OF THE INVENTION

The invention generally relates to a communication network. More specifically, the invention relates to method, system, and apparatus for handover amongst a plurality of communication networks.

### BACKGROUND OF THE INVENTION

A communication network includes at least one gateway. Each gateway of the at least one gateway communicates with a plurality of Base Stations (BSs) for transferring data packets. Further, each BS of the plurality of BSs communicates with one or more Mobile Stations (MSs). Each MS of the plurality of MSs receives and transmits data packets by establishing an Internet Protocol (IP) session with one or more BSs of the plurality of BSs.

Examples of a communication network are Worldwide Interoperability for Microwave Access (WiMAX) communication network, third Generation Partnership Project (3GPP) communication network, and Long Term Evolution (LTE) communication network. In a WiMAX communication network, a gateway is an Access Service Network (ASN) Gateway. In a 3GPP communication network, a gateway is a Serving GPRS Support Node (SGSN) and a BS is a (e)NodeB.

A MS in a first communication network establishes an IP session with one or more BSs operating in the first communication network. The MS may move into a second communication network. Then, to provide uninterrupted communication services to the MS, the MS may be handed over to a target BS in the second communication network. However, to handover the MS between different communication networks, the IP session established by the MS in the first communication network is terminated and a new IP session is established between the MS and the target BS in the second communication network. This may lead to inconvenience to a user of the MS.

Therefore, there is a need for a method, system, and apparatus for handover of a MS amongst a plurality of communication network without interrupting the IP session of the MS.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a block diagram showing an environment in which various embodiments of the invention may function.

FIG. 2 illustrates a method for enabling handover of a Mobile Station (MS) amongst a plurality of communication networks, in accordance with an embodiment of the invention.

FIG. 3 illustrates a method for enabling handover of a MS amongst a plurality of communication networks, in accordance with another embodiment of the invention.

FIG. 4 illustrates a system for enabling handover of a MS amongst a plurality of communication networks, in accordance with an embodiment of the invention.

FIG. 5 illustrates an apparatus for enabling handover of a MS amongst a plurality of communication networks, in accordance with an embodiment of the invention.

FIG. 6 illustrates an apparatus for enabling handover of a MS amongst a plurality of communication networks, in accordance with another embodiment of the invention.

FIG. 7 illustrates a process flow diagram for performing handover of a MS from a 3GPP communication network to a WiMAX communication network, in accordance with an exemplary embodiment of the invention.

FIG. 8 illustrates a process flow diagram for performing handover of a MS from a WiMAX communication network to and a 3GPP communication network, in accordance with an exemplary embodiment of the invention.

### DETAILED DESCRIPTION OF THE INVENTION

Before describing in detail embodiments that are in accordance with the invention, it should be observed that the embodiments reside primarily in combinations of method steps and apparatus components related to handover amongst a plurality of communication networks. Accordingly, the apparatus components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Various embodiments of the invention provide methods, systems and apparatuses for enabling handover of a Mobile Station (MS) amongst a plurality of communication networks. The MS operates in one or more communication networks of the plurality of communication networks using an Internet Protocol (IP) session. The method includes communicating one or more network parameters amongst the plurality of communication networks. The method further includes creating one or more datapath parameters based on one or more of the one or more network parameters. The method further includes altering one or more protocol stack parameters in the MS. Altering the one or more protocol stack parameters maintains the IP session operating the MS in the one or more communication networks.

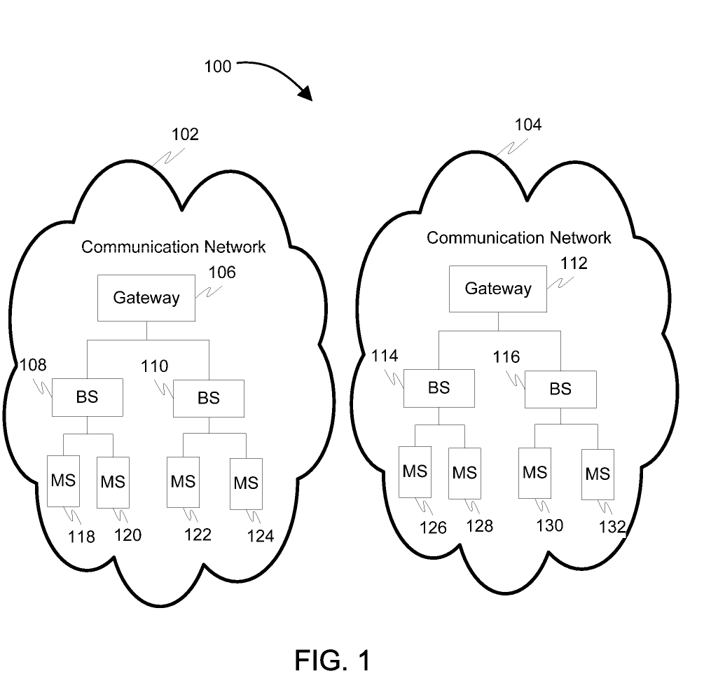

FIG. 1 illustrates a block diagram showing an environment 100 in which various embodiments of the invention may function. Environment 100 includes a communication network 102 and a communication network 104. Examples of a communication network may include, but are not limited to a Wireless Interoperability Microwave Access (WiMAX) communication network, a 3rd Generation Partnership Project (3GPP), Long Term Evolution (LTE) network, a 3rd Generation Partnership Project 2 (3GPP2), Ultra Mobile Broadband (UMB) network, a Wireless Fidelity (WiFi) network, and any variant of an Orthogonal Frequency Division Multiple Access (OFDMA) communication network.

Communication network 102 includes one or more gateways such as, a gateway 106, and a first plurality of Base Stations (BSs) such as, a BS 108 and a BS 110. The one or more gateways in communication network 102 may communicate with each other (not shown in the FIG. 1). Further, the one or more gateways in communication network 102 may communicate with the first plurality of BSs. For example, gateway 106 communicates with BS 108 and BS 110. Similarly, communication network 104 includes one or more gateways such as, a gateway 112, and a second plurality of BSs such as, a BS 114 and a BS 116. The one or more gateways may communicate with each other (not shown in the FIG. 1). Further, the one or more gateways in communication network 104 communicate with the second plurality of BSs. For example, gateway 112 communicates with BS 114 and BS 116.

Further, in communication network 102 the first plurality of BSs communicates with a first plurality of Mobile Stations (MSs), such as, a MS 118, a MS 120, a MS 122, and a MS 124, to provide various communication services. For example, BS 108 communicates with MS 118 and MS 120, and BS 110 communicates with MS 122 and MS 124. Similarly, in communication network 104 the second plurality of BSs communicates with a second plurality of MSs, such as, a MS 126, a MS 128, a MS 130, and a MS 132 to provide various communication services. For example, BS 114 communicates with MS 126 and MS 128, and BS 116 communicates with MS 130 and MS 132. A MS may be a single radio device. Alternatively, MS may be a dual radio device. Examples of a MS may include, but are not limited to a laptop, a personal digital assistant (PDA), a mobile phone, and any hand-held devices using which a subscriber avails the various communication services. An MS avails communication services by establishing an Internet Protocol (IP) session with one or more serving BSs. Example of the communication services may include, but are not limited to web browsing, voice call, data transfer, text messaging, multimedia content messaging, and video streaming.

Communication network 102 may be a WiMAX communication network. In this case, each of the one or more gateways in communication network 102 is an Access Service Network (ASN)-Gateway. Additionally, communication network 104 may be a 3GPP communication network. In this case, each of the one or more gateways in communication network 104 is a Serving GPRS Node (SGSN). Additionally, each one of the second plurality of BSs is an enhanced Node Base Station (e)NodeB.

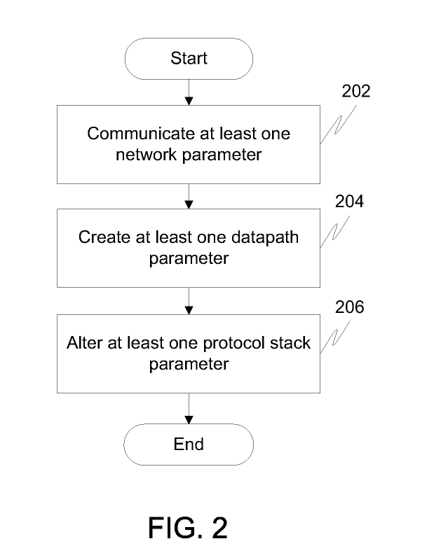

FIG. 2 illustrates a method for enabling handover of a MS amongst a plurality of communication networks, in accordance with an embodiment of the invention. The MS operating in a communication network of the plurality of communication networks may move into another communication network of the plurality of communication networks. In this case, a handover of the MS may be required, such that, the MS receives uninterrupted communication services. To facilitate this handover, at step 202, one or more network parameters are communicated amongst the plurality of communication networks. Examples of a network parameter may include, but are not limited to a Quality Of Service (QoS) information, a Class of Service (CoS) information, a Grade of Service (GoS) information, a static Internet Protocol (IP) address of the MS, a Quality Class Information (QCI), a Packet Data Protocol (PDP) context Information and a Traffic Class Information (TCI). The MS operates in one or more of the plurality of communication networks using an IP session. A static IP address is associated with the MS to uniquely identify the MS in the IP session. For example, MS 126 operating in communication network 104 may move into communication network 102. In this case, a handover of MS 126 from communication network 104 to communication network 102 is required. To facilitate this handover, one or more network parameters such as QoS information, CoS information and static IP address of MS 126 is communicated to communication network 102.

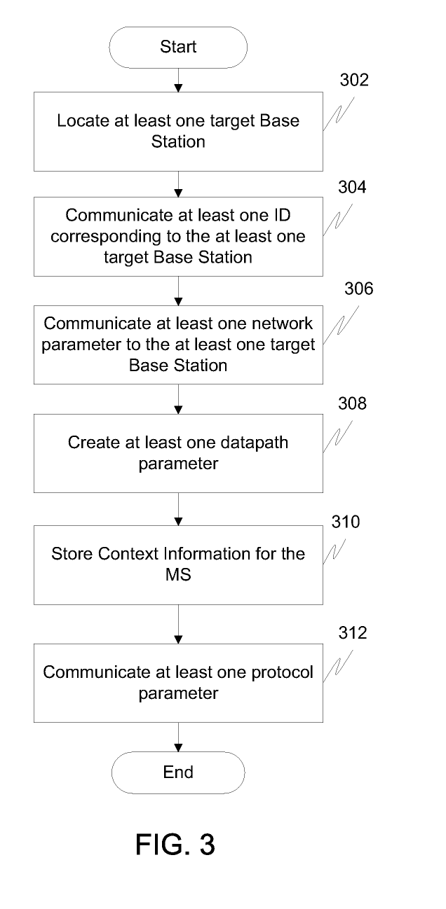

Based on the one or more network parameters, one or more datapath parameters are created at step 204. Datapath parameters are used to define data path route in a communication network. For example, in a 3GPP communication network, a datapath parameter is required to define the data path route between a MS, a (e)NodeB, and a SGSN. Additionally, based on the one or more network parameters, a context information for the MS may also be created. This is further explained in detail conjunction with FIG. 3.

After the handover, the MS should be able to avail communication services without any interruption in the IP session. Accordingly at step 206, one or more protocol stack parameters are altered in the MS. Altering the one or more protocol stack parameters enables the MS to avail the communication services without any interruption in the IP session. Examples of protocol stack parameter may include, but are not be limited to a Transfer Control Protocol/Internet Protocol (TCP/IP) parameter, Stream Control Transmission Protocol (SCTP) parameter, Resource ReSerVation Protocol (RSVP) parameter, and Internet Protocol Security (Ipsec) parameter.

For example, MS 126 avails communication services using an IP session in communication network 104. During the handover of MS 126 from communication network 104 to communication network 102, the difference in network protocol parameters of communication network 104 and network protocol parameters of communication network 102 may cause an interruption in the IP session of MS 126. This may lead to loss of connectivity for MS 126. To avoid this, TCP/IP parameter and IPsec parameter are altered in MS 126, thereby enabling MS 126 to avail communication services without any interruption in the IP session after the handover.

FIG. 3 illustrates a method for enabling handover of a MS amongst a plurality of a plurality of communication networks, in accordance with another embodiment of the invention. The MS operating in a communication network of the plurality of communication networks may move into another communication network of the plurality of communication networks. In this case, a handover of the MS may be required, such that, the MS receives uninterrupted communication services.

For initiating the handover, one or more target BSs in one or more of the plurality of communication networks are located at step 302. Thereafter, one or more IDs for the one or more target BSs are communicated at step 304. The one or more IDs may be communicated to the MS. For example, when MS 126 moves into communication network 102, BS 110 is identified as a target BS for handover of MS 126. An ID for BS 110 is identified and communicated to MS 126. Communication network 102 may be a 3GPP communication network. In this case, BS 110 is a (e)NodeB and gateway 106 is a SGSN. Therefore, an ID for (e)NodeB is communicated to the SGSN, which identifies the (e)NodeB. Alternatively, communication network 102 may be a WiMAX communication network. In this case, gateway 106 is an ASN-GW. Therefore, an ID for BS 110 is communicated to the ASN-GW, which identifies BS 110.

At step 306, one or more network parameters are communicated to the one or more target BSs. Thereafter, at step 308, one or more datapath parameters are created in the one or more target BSs based on the one or more network parameters. This has been explained in conjunction with FIG. 2. Alternatively, the one or more datapath parameters may be created in a gateway. For example, communication network 102 may be a 3GPP communication network. In this case, to handover MS 126 to communication network 102, one or more datapath parameters are created in one or more target (e)NodeBs. By way of another example, communication network 102 may be a WiMAX communication network. In this case, one or more datapath parameters are created in an ASN-GW in the WiMAX communication network.

In addition to the one or more datapath parameters, at step 310, context information for the MS is stored in the one or more target BSs. Alternatively, context information for the MS is stored in a gateway. In an embodiment of the invention, the context information is retrieved from the MS. For example, communication network 102 is a WiMAX communication network. In this case, when MS 126 moves into communication network 102, context information is retrieved from the MS. In another embodiment of the invention, the context information is created based on the one or more network parameter. For example, communication network 102 is a 3GPP communication network. In this case, when MS 126 moves into communication network 102, context information is created based on the one or more network parameters.

The MS should be able to avail the communication services without any interruption in the IP session, accordingly at step 312, one or more protocol parameters are communicated to the MS. Based on the one or more protocol parameters, one or more protocol stack parameters in the MS are altered to enable the MS to avail the communication services without interrupting the IP session established with one or more serving BSs after handover of the MS. For example, during handover of MS 126 from communication network 104 to communication network 102, the TCP/IP parameters and the IPsec parameters in the MS are altered based on network protocols of communication network 102. In such a case, network protocols of communication network 104 may be different from the network protocols of communication network 102. Altering of the TCP/IP parameters and the IPsec parameters in the MS ensures the handover of the MS without interrupting the IP session established with one or more serving BSs in the communication network 102.

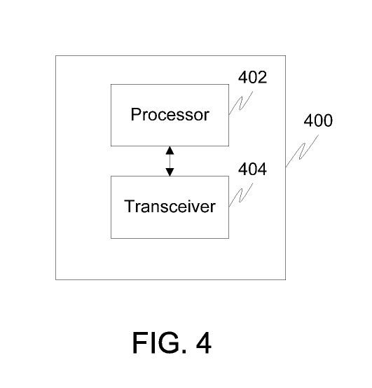

FIG. 4 illustrates a system 400 for enabling handover of a MS amongst a plurality communication networks, in accordance with an embodiment of the invention. System 400 includes a processor 402 and a transceiver 404.

Transceiver 404 communicates one or more network parameters amongst the plurality of communication networks. Example of a network parameter may include, but is not be limited to Quality of Service (QoS) information, Class of Service (CoS) information, Grade of Service (GOS) information, static Internet Protocol (IP) address of the MS, Quality Class Information (QCI), and Traffic Class Information (TCI). Transceiver 404 may receive the one or more network parameters from the MS. In another embodiment of the invention, transceiver 404 receives the one or more network parameters from one or more serving BSs. Thereafter, transceiver 404 may locate one or more target BSs and transmit the one or more network parameters to the one or more target BSs. This has been explained in detail in conjunction with FIG. 2 and FIG. 3.

Processor 402 may analyze the one or more network parameters and create one or more datapath parameters based on the one or more network parameters. Transceiver 404 may then transmit the one or more datapath parameters to the one or more target BSs. Further, transceiver 404 may transmit one or more protocol parameters to the MS. Processor 402 may then alter the one or more protocol stack parameters in the MS based on the one or more protocol parameters. This enables the MS to avail the communication services without interrupting the IP session established with one or more serving BSs. This has been explained in detail in conjunction with FIG. 2 and FIG. 3.

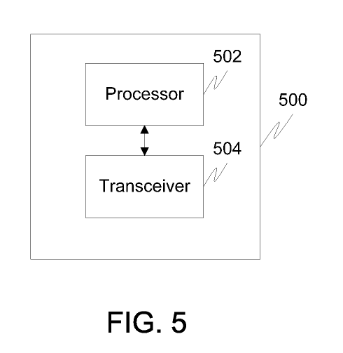

FIG. 5 illustrates an apparatus 500 for enabling handover of a MS amongst a plurality of communication networks, in accordance with an embodiment of the invention. Apparatus 500 includes a processor 502 and a transceiver 504. Apparatus 500 may be a Single Radio Server (SRS). The SRS may be located in any one of ASN-GW, GGSN, SGSN, BS, (e)NodeB and a MS. Further, a unique IP address may be assigned to the SRS.

Transceiver 504, may receive one or more first network parameters from a first set of communication networks of the plurality of communication networks. The MS operates in one or more of the first set of communication networks using an IP session. Thereafter, processor 502 converts the one or more first network parameters to one or more second network parameters. The one or more second network parameters are compatible with a second set of communication networks of the plurality of communication networks.

Processor 502 identifies one or more target BSs operating in a second communication network of the plurality of communication networks. Transceiver 504 then transmits the one or more second network parameters to the one or more target BSs. Alternatively, processor 502 creates one or more datapath information based on the one or more first network parameters. Thereafter, transceiver 504 transmits the one or more datapath information to the one or more target BSs. Additionally, transceiver 504 transmits the one or more protocol parameter to the MS. This has been explained in conjunction with FIG. 2 and FIG. 3.

For example, apparatus 500, which is a SRS, enables handover of MS 126, which is a single radio MS, from communication network 104 to communication network 102. In this example, communication network 104 is a 3GPP communication network and communication network 102 is a WiMAX communication network. In such a case, transceiver 504 receives network parameters, for example, QoS information, QCI information, TCI information and static IP address of the MS from communication network 104, which is a 3GPP communication network. Processor 502 converts the network parameters to make them compatible with communication network 102, which is a WiMAX communication network. Thereafter, processor 502 identifies BS 110 in communication network 102 as the target BS and communicates the network parameters to BS 110 after conversion. Alternatively, processor 502 creates one or more datapath parameters compatible with the WiMAX communication based on the network parameters converted by processor 502. Thereafter, transceiver 504 transmits the one or more datapath parameters to BS 110. Further, to ensure uninterrupted IP session for MS 126 after handover, transceiver 504 transmits one or more protocol parameters to MS 126. The one or more protocol parameters are used to alter one or more protocol stack parameters in MS 126.

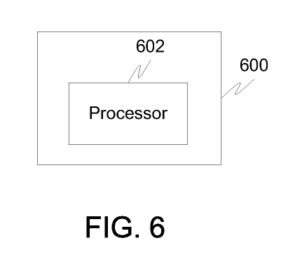

FIG. 6 illustrates an apparatus 600 for enabling handover of a MS amongst one or more communication networks, in accordance with another embodiment of the invention. Apparatus 600 may be the MS. Alternatively, apparatus 600 may be one of a BS operating in one of the plurality of communication networks and a gateway operating in one of the plurality of communication networks.

Apparatus 600 includes a processor 602. Processor 602 analyzes one or more network parameters. Based on one or more of the one or more network parameters, processor 602 creates one or more datapath parameters. Additionally, processor 602 creates one or more context information for the MS based on one or more of the one or more network parameters. This has been explained in detail in conjunction with FIG. 4 and FIG. 5.

Additionally, processor 602 creates one or more protocol parameters. Processor 602 alters one or more protocol stack parameters in the MS based on the one or more protocol parameter. The alterations enable the handover of the MS without interrupting an IP session operating the MS in one or more of the plurality of communication networks.

For example, apparatus 600 is MS 126, which is a single radio MS. MS 126 enables its handover from communication network 104 to communication network 102. Communication network 104 is a 3GPP communication network and communication network 102 is a WiMAX communication network. In such a case, MS 126 analyzes network parameters, for example, QoS information, QCI information, TCI information, and static IP address of MS 126. Based on the network parameters, MS 126 creates datapath parameters. The datapath parameters are required to define the data path route between MS 126, a target BS of the plurality of BSs in the WiMAX communication network, and an ASN-GW operating in the WiMAX communication network. Further, MS 126 identifies BS 110 as the target BS. Thereafter, MS 126 creates context information for MS 126 based on the network parameters. Further, MS 126 creates protocol parameters based on which protocol stack parameters of MS 126 such as Transfer Control Protocol/Internet Protocol (TCP/IP) parameter and Internet Protocol Security (Ipsec) parameter are altered. The alterations enable the handover of MS 126 without interrupting an IP session operating MS 126 in communication network 104.

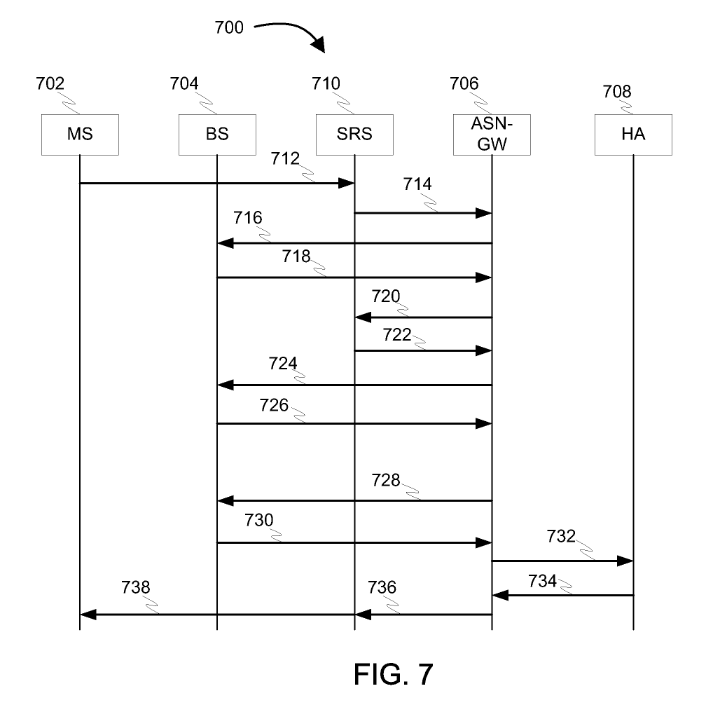

FIG. 7 illustrates a process flow diagram 700 of handover of a MS 702 from a 3GPP communication network to a WiMAX communication network, in accordance with an exemplary embodiment of the invention. MS 702 operates in the 3GPP communication network. The WiMAX communication network includes a BS 704, an ASN-GW 706, and a Home Agent (HA) 708. HA 708 provides data transfer services in the WiMAX communication network. A Single Radio Server (SRS) 710 enables the handover of MS 702 from the 3GPP communication network to the WiMAX communication network.

As shown in process flow diagram 700, at step 712, MS 702 transmits a Handover (HO)-request signal to SRS 710 requesting a handover to the WiMAX communication network. The HO-request signal includes one or more IDs for one or more BSs in the WiMAX communication network. Additionally, the HO-request signal includes QoS information, QCI information, CoS information, PDP context information, a request for acknowledgement of the HO-request signal, Service Flow Identifiers (SFIDs), and a static IP address of MS 702. MS 702 utilizes the static IP address to operate in the 3GPP communication network. Further, the HO-request signal includes an IP address corresponding to SRS 710. The HO-request signal is transmitted over existing User Datagram Protocol (UDP) ports.

At step 714, SRS 710 transmits a request to ASN-GW 706 to handover MS 702 to the WiMAX communication network. Additionally, ASN-GW 706 identifies BS 704 from the one or more BSs based on an ID from the one or more IDs in the HO-request signal. At step 716, ASN-GW 706 transmits a request to BS 704 to create one or more datapath parameters to enable MS 702 to operate in the WiMAX communication network. At step 718, BS 704 sends an acknowledgement to ASN-GW 706 in response to the request. On receiving the acknowledgement from BS 704, at step 720, ASN-GW 706 transmits a HO-Response signal to SRS 710. At step 722, SRS 710 sends an acknowledgement to ASN-GW 706 in response to the HO-Response signal.

At step 724, ASN-GW 706 transmits a HO-Confirmation signal to BS 704. HO-Confirmation signal may include QoS information, an ID of BS 704, PDP context information, and static IP address of MS 702 received with the HO-request signal. Alternatively, the HO-Confirmation signal may include one or more datapath parameters created by SRS 710 based on the QoS information, the PDP context information, and the static IP address of MS 702. BS 704 acknowledges the HO-Confirmation signal by transmitting a signal at step 726 to ASN-GW 706.

Thereafter, a new session is established for MS 702 in the WiMAX communication network. At step 728, ASN-GW 706 creates a datapath required for the MS 702 to operate in the WiMAX communication network and communicates the datapath to BS 704. At step 730, BS 704, sends an acknowledgement to ASN-GW 706 on receiving the datapath.

A permanent internet protocol (IP) address is to be maintained for MS 702 during the handover. Accordingly, at step 732, ASN-GW 706 transmits a Mobile Internet Protocol (MIP)-Registration signal to HA 708. At step 734, HA 708 maintains the permanent IP address and transmits an acknowledgement to ASN-GW 706. ASN-GW 706 transmits a signal corresponding to the completion of the handover to SRS 710 at step 736.

At step 738, SRS 710 transmits a HO-Response signal to MS 702. Additionally, the HO-WiMAX-Response signal includes an ID corresponding to the permanent IP address of MS 702. Further, the HO-Response signal includes an ID corresponding to BS 704. The various signals utilized in the exemplary embodiment may be transmitted over existing signaling interfaces, such as, R4 and R6 etc. Alternatively, the various signals may be transmitted over existing end-to-end transport protocols such as Transfer Control Protocol (TCP), User Datagram Protocol (UDP), Stream Control Transmission Protocol (SCTP) and Datagram Congestion Control Protocol (DCCP).

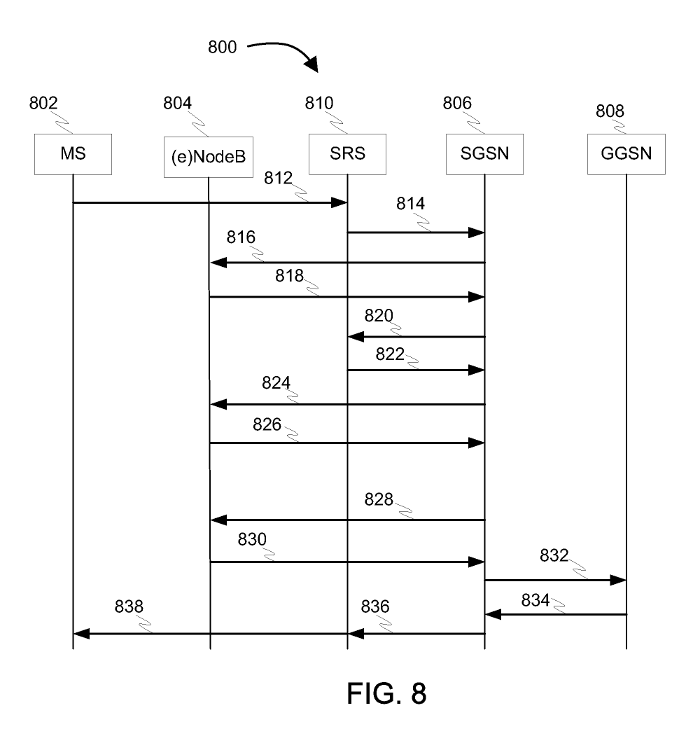

FIG. 8 illustrates a process flow diagram 800 of handover of a MS 802 from a WiMAX communication network to a 3GPP communication network, in accordance with an exemplary embodiment of the invention. MS 802 operates in the WiMAX communication network. The 3GPP communication network includes a (e)NodeB 804, a Serving GPRS Support Node (SGSN) 806, a Gateway GPRS Support Node (GGSN) 808. Gateway GPRS Support Node (GGSN) 808 provides data transfer services to the 3GPP communication network. A SRS 810 enables the handover of MS 802 from the WiMAX communication network to the 3GPP communication network.

At step 812, MS 802 transmits a Handover (HO)-request signal to SRS 810 requesting a handover to the 3GPP communication network. The HO-request signal includes one or more IDs for one or more (e)NodeBs in the 3GPP communication network. Additionally, the HO-request signal includes network parameters such as QoS information, QCI information, CoS information, and static IP address of MS 802. The static IP address is utilized by MS 802 to operate in the WiMAX communication network. Further, the HO-request signal includes an Internet Protocol (IP) address corresponding to SRS 810. The HO-request signal is transmitted over existing User Datagram Protocol (UDP) ports. Alternatively, the HO-request signal may be transmitted over Transfer Control Protocol (TCP) ports. The network parameters received are compatible with the WiMAX communication network. Therefore, for a handover of MS 802, SRS 810 converts the network parameters, such that they are compatible with the 3GPP communication network.

At step 814, SRS 810 transmits a request to SGSN 806 to handover MS 802 to the 3GPP communication network. Additionally, SGSN 806 identifies (e)NodeB 804 based on an ID from the one or more IDs in the HO-request signal. At step 816, SGSN 806 transmits a request to (e)NodeB 804 to create one or more datapath parameters to enable MS 802 to operate in the 3GPP communication network. At step 818, (e)NodeB 804 sends an acknowledgement to SGSN 806 in response to the request. On receiving the acknowledgement from (e)NodeB 804, at step 820, SGSN 806 transmits a HO-Response signal to SRS 810. At step 822, SRS 810 sends an acknowledgement to SGSN 806 in response to the HO-Response signal.

At step 824, SGSN 806 transmits a HO-Confirmation signal to (e)NodeB 804. The HO-Confirmation signal includes the network parameter converted by SRS 810. Alternatively, the HO-Confirmation signal may include one or more datapath parameters created by SRS 810 based on the network parameter received by SR 810. (e)NodeB 804 acknowledges the HO-Confirmation signal by transmitting a signal at step 826.

Thereafter, a new session is established for MS 802 in the 3GPP communication network. At step 828, SGSN 806 creates a datapath required for the MS 802 to operate in the WiMAX communication network and communicates the datapath to (e)NodeB 804. At step 830, (e)NodeB 804 sends an acknowledgement to SGSN 806 on receiving the datapath.

A permanent internet protocol (IP) address is to be maintained for MS 802 during the handover. Accordingly, at step 832, SGSN 806 transmits a MIP-Registration signal to GGSN 808. At step 834, GGSN 808 maintains the permanent IP address and transmits an acknowledgement to SGSN 806. SGSN 806 transmits a signal corresponding to the completion of the handover to SRS 810 at step 836.

At step 838, SRS 810 transmits a HO-Response signal to MS 802. The HO-Response signal includes an ID corresponding to the permanent IP address of MS 802. Further, the HO-Response signal includes an ID corresponding to (e)NodeB 804.

Various embodiments of the invention provide methods and apparatuses for handover of the MS amongst a plurality of communication networks. In this method, a MS is seamlessly handed over from a first communication network to a second communication network without interrupting an IP session of the MS. This is enabled by using a SRS, which facilitates communication between the first communication network and the second communication network. Additionally, one or more protocol stack parameters in the MS are altered to ensure an uninterrupted IP session after handover of the MS.

Those skilled in the art will realize that the above-recognized advantages and other advantages described herein are merely exemplary and are not meant to be a complete rendering of all of the advantages of the various embodiments of the invention.

In the foregoing specification, specific embodiments of the invention have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method for enabling handover of a mobile station (MS) amongst a plurality of communication networks, the method comprising:
communicating at least one network parameter amongst the plurality of communication networks, wherein the MS operates in at least one communication network of the plurality of communication networks using an internet protocol (IP) session;
creating at least one datapath parameter based on at least one of the at least one network parameter; and
altering at least one protocol stack parameter in the MS, wherein altering maintains the IP session operating the MS in at least one communication network of the plurality of communication networks.

2. The method of claim 1 further comprising storing a context information for the MS.

3. The method of claim 2, wherein the context information is created from the at least one of the at least one network parameter.

4. The method of claim 2, wherein the context information is retrieved from the MS.

5. The method of claim 1, wherein the at least one network parameter comprises at least one of Quality of Service (QoS) information, Class of Service (CoS) information, Grade of Service (GOS) information, static Internet Protocol (IP) address of the MS, Quality Class Information (QCI), and Traffic Class Information (TCI).

6. The method of claim 1 further comprising locating at least one target base station operating in at least one communication network of the plurality of communication networks.

7. The method of claim 6 further comprising communicating at least one ID corresponding to the at least one target base station.

8. The method of claim 6, wherein the at least one network parameter is communicated to the at least one target base station.

9. The method of claim 1 further comprising communicating at least one protocol parameter.

10. The method of claim 9, wherein the at least one protocol stack parameter is altered based on the at least one protocol parameter.

11. The method of claim 1, wherein a communication network of the plurality of communication networks is one of a Worldwide Interoperability for Microwave Access (WiMAX) communication network, 3rd Generation Partnership Project (3GPP) Long Term Evolution (LTE) network, 3rd Generation Partnership Project 2 (3GPP2), Ultra Mobile Broadband (UMB) network, Wireless Fidelity (WiFi) network, and Orthogonal Frequency Division Multiple Access (OFDMA) communication network having a backhaul link.

12. A system for enabling handover of a Mobile Station (MS) amongst a plurality of communication networks, the system comprising:
a transceiver configured to communicate at least one network parameter amongst a plurality of communication networks, wherein the MS operates in at least one communication network of the plurality of communication networks using an Internet Protocol (IP) session; and
a processor configured to:
create at least one datapath parameter based on at least one of the at least one network parameter; and
alter at least one protocol stack parameter in the MS, wherein altering maintains the IP session operating the MS in at least one communication network of the plurality of communication networks.

13. The system of claim 12, wherein the transceiver is further configured to locate at least one target Base Station (BS) operating in at least one communication network of the plurality of communication networks.

14. The system of claim 13, wherein the transceiver is further configured to communicate the at least one network parameter to the at least one target BS.

15. The system of claim 12, wherein the transceiver is further configured to communicate the at least one datapath parameter to the at least one target BS.

16. The system of claim 12, wherein the processor is configured to create at least one protocol parameter.

17. The system of claim 16, wherein transceiver communicates the at least one protocol parameter to the MS.

18. An apparatus for enabling handover of a Mobile Station (MS) amongst a plurality of communication networks, the apparatus comprising:
a processor configured to convert at least one first network parameter received from a first set of communication network of the plurality of communication networks to at least one second network parameter, wherein the MS operates in at least one of the first set of communication network using an internet protocol (IP) session; and
a transceiver transmitting the at least one second network parameter to a second set of communication network of the plurality of communication network.

19. The apparatus of claim 18, wherein the processor is further configured to identify at least one target base station operating in at least one communication network of the plurality of communication networks.

20. The apparatus of claim 19, wherein the transceiver is further configured to communicate at least one datapath information to the at least one target base station.

21. The apparatus of claim 19, wherein the transceiver is further configured to communicate at least one protocol parameter to the MS.

22. The apparatus of claim 19, wherein the transceiver is further configured to receive the at least one first network parameter.

23. An apparatus for enabling handover of a Mobile Station (MS) amongst a plurality of communication networks, the apparatus comprising:
a processor configured to:
analyze at least one network parameter;
create at least one datapath parameter based on at least one of the at least one network parameter; and
alter at least one protocol stack parameter in the MS, wherein altering maintains an IP session operating the MS in at least one communication network of the plurality of communication networks.

24. The apparatus of claim 23 further comprising a transceiver configured to locate at least one target base station operating in at least one communication network of the plurality of communication networks.

25. The apparatus of claim 23, wherein the processor is configured to create at least one protocol parameter.

26. The apparatus of claim 23, wherein the processor is configured to create a context information for the MS.

27. The apparatus of claim 23, wherein the apparatus is the MS.

28. The apparatus of claim 23, wherein the apparatus is a Base Station (BS) operating in one of the plurality of communication networks.

29. The apparatus of claim 23, wherein the apparatus is a gateway operating in one of the plurality of communication networks.
